(19) United States
(12) Patent Application Publication
(10) Pub. No.: US 2003/0179308 A1
(43) Pub. Date: Sep. 25, 2003

(54) Augmented tracking using video, computed data and/or sensing technologies

(76) Inventors: Lucia Zamorano, West Bloomfield, MI (US); Abhilash Pandya, Southgate, MI (US)

Correspondence Address: KENYON & KENYON, One Broadway, New York, NY, 10004, US

(21) Appl. No.: 10/101,421

(22) Filed: Mar. 19, 2002

(51) Int. Cl. H04N 5/222

(52) U.S. Cl. 348/333.12; 348/333.02

(57) ABSTRACT

A system for generating an augmented reality image comprises a video camera for obtaining video data and a sensor for obtaining sensed data. An augmented reality processor is coupled to the video camera and to the sensor. The augmented reality processor is configured to receive the video data from the video camera and to receive the sensed data from the sensor and to receive other types of computed data, such as any imaging modality. A display device is coupled to the augmented reality processor. The augmented reality processor is further configured to generate for display on the display device a video image from the video data received from the video camera and to generate a corresponding data image from the sensed data received from the sensor or other computed data. The augmented reality processor is further configured to merge the video image and the corresponding data image generated from computed data or sensed data so as to generate the augmented reality image. The system employs a tracking system that tracks the position of the video camera. The system may also employ a robotic positioning device for positioning the video camera, and which may be coupled to the tracking system for providing precise position information.

### FIELD OF THE INVENTION

The present invention relates to an augmented reality system. More specifically, the present invention relates to a system for augmenting a real-time video image with a data image corresponding to computed data (such as derived from different types of imaging, e.g., computed tomography, MRI, PET, SPECT, etc.) and/or to sensed data.

### BACKGROUND INFORMATION

The use of video cameras to provide a real-time view of an object is well-known. Typically, a video camera obtains visual data about an object of interest and displays the visual data corresponding to the item of interest on a display device, such as a television or monitor. Aided by the visual data as it is displayed on the display device, a person may then perform an operation on the item of interest. The number of uses for which such a system may be employed are too numerous to mention.

By way of example, video cameras are commonly employed during the performance of a surgical procedure. For instance, in the course of a surgical procedure, a surgeon may insert a video camera and a surgical instrument into an area of a patient's body. By viewing a display device that displays the real-time visual data obtained by the video camera, the surgeon may then manipulate the surgical tool relative to the patient's body so as to obtain a desired surgical effect. For example, a video camera and a surgical tool may be inserted simultaneously into a patient's brain during brain surgery, and, by viewing the visual data obtained by the camera and displayed on an associated display device, the surgeon may use the surgical tool to remove a cancerous tissue growth or brain tumor in the patient's brain. Since the visual data is being obtained by the camera and is being displayed on the associated display device in real-time, the surgeon may see the surgical tool as it is manipulated, and may determine whether the manipulation of the surgical tool is having the desired surgical effect.

One disadvantage of this method of using a video camera is that it provides a user with only a single type of data, e.g., visual data, on the display device. Other data, e.g., computed data or sensed data, that may be useful to a user, e.g., a surgeon, cannot be viewed simultaneously by the user, except by viewing the other data via a different display means. For instance, in the above-described example, prior to performing a brain surgery operation, the surgeon may also have performed an MRI in order to verify that the brain tumor did in fact exist and to obtain additional data about the size and location of the brain tumor. The MRI may obtain magnetic resonance data corresponding to the patient's brain and may display the magnetic resonance data, for instance, in various slides or pictures showing the patient's brain from various angles. The surgeon may then refer to one or more of these slides or pictures generated during the MRI while performing the brain surgery operation, in order to better recognize or conceptualize the size and location of the brain tumor when seen via the video camera. While this additional data may be somewhat helpful to the surgeon, it requires the surgeon to view two different displays or types of displays and to figure out how the differently displayed data complements each other.

### SUMMARY OF THE INVENTION

The present invention, according to one example embodiment thereof, relates to a system for generating an augmented reality image including a video camera for obtaining video data and a sensor for obtaining sensed data. The system may also include a connection to obtain computed data, e.g., MRI, CT, etc., from a computed data storage module. An augmented reality processor is coupled to the video camera and to the sensor. The augmented reality processor is configured to receive the video data from the video camera and to receive the sensed data from the sensor. A display device is coupled to the augmented reality processor. The augmented reality processor is further configured to generate for display on the display device a video image from the video data received from the video camera and to generate a corresponding data image from the sensed data received from the sensor and/or a corresponding registered view from the computed data (i.e. imaging). The augmented reality processor is further configured to merge the video image and the corresponding data image so as to generate an augmented reality image. The system may employ a tracking system that tracks the position of the video camera. The system may also employ a robotic positioning device for positioning the video camera, and which may be coupled to the tracking system for providing precise position information. By tracking the precise locations of the various components of the augmented reality system, either by employing the kinematics of the robotic positioning system or by another tracking technique, the various data obtained from the components of the system may be registered both in space and in time, permitting the video image displayed as a part of the augmented reality image to correspond precisely to the data image (e.g., computed data or sensed data) displayed as part of the augmented reality image.

### BRIEF DESCRIPTION OF THE DRAWINGS

FIG. 1 is a schematic diagram that illustrates some of the components of an augmented reality system, in accordance with one embodiment of the present invention;

FIG. 2 is a schematic diagram that illustrates a robotic positioning device having four robotic position device segments, according to one embodiment of the present invention;

FIG. 3(a) is a diagram illustrating a video image displayed on a display device, according to one embodiment of the present invention;

FIG. 3(b) is a diagram that illustrates a data image displayed on a display device, according to one embodiment of the present invention;

FIG. 3(c) is a diagram that illustrates an augmented reality image merging the video image of FIG. 3(a) and the data image of FIG. 3(b); and

FIG. 4 is a diagram that illustrates a reference system that may be employed by an augmented reality processor in order to determine positions and orientations of an object of interest, according to one embodiment of the present invention.

### DETAILED DESCRIPTION

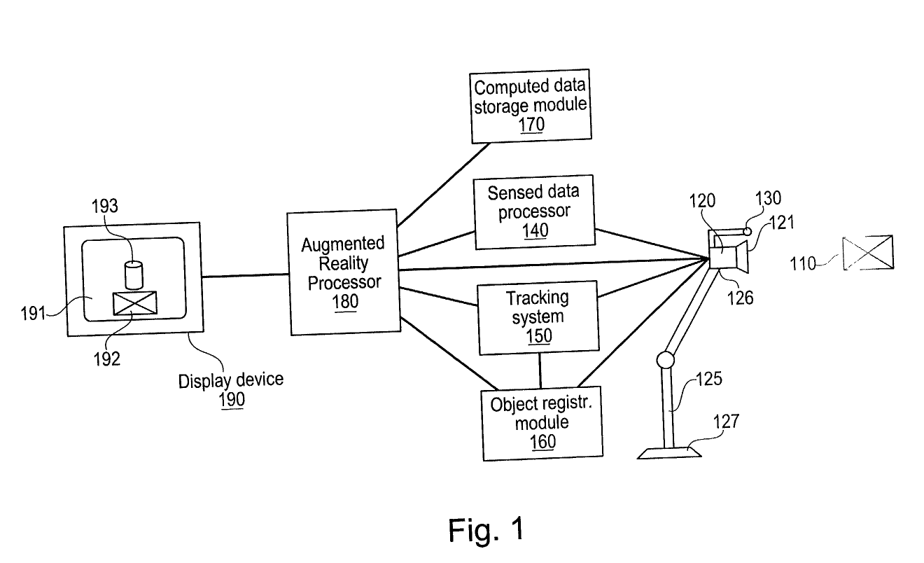

FIG. 1 is a schematic diagram that illustrates some of the components of an augmented reality system 100, in accordance with one example embodiment of the present invention. For the purposes of clarity and conciseness, the augmented reality system 100 of the present invention will be described hereinafter as a system that may be used in the performance of a surgical procedure. Of course, it should be understood that the system of the present invention may be used in a myriad of different applications, and is not intended to be limited to a system for performing surgical procedures. Various alternative embodiments are discussed in greater detail below.

In the embodiment shown in FIG. 1, the augmented reality system 100 of the present invention employs a robotic positioning device 125 to position a video camera 120 in a desired position relative to an object of interest 110. Advantageously, the video camera 120 is positioned at an end-effector 126 of the robotic positioning device 125. The object of interest 110 may be any conceivable object, although for the purposes of example only, the object of interest 110 may be referred to hereinafter as a brain tumor in the brain of a patient.

In addition, the augmented reality system 100 of the present invention employs the robotic positioning device 125 to position a sensor 130 in a desired position relative to the object of interest 110. The sensor 130 may be any conceivable type of sensor capable of sensing a condition at a location near or close to the object of interest 110. For instance, the sensor 130 may be capable of sensing a chemical condition, such as the pH value, O₂ levels, CO₂ levels, lactate, choline and glucose levels, etc., at or near the object of interest 110. Alternatively, the sensor 130 may be capable of sensing a physical condition, such as sound, pressure flow, electrical activity, magnetic activity, etc., at or near the object of interest 110.

A tracking system 150 is coupled to at least one of the robotic positioning device 125 and the video camera 120. The tracking system 150 is configured, according to one example embodiment of the present invention, to determine the location of at least one of the video camera 120, the robotic positioning device 125 and the sensor 130. According to one embodiment, the tracking system 150 is employed to determine the precise location of the video camera 120. According to another embodiment, the tracking system 150 is employed to determine the precise location of the sensor 130. In either of these embodiments, the tracking system 150 may employ forward kinematics to determine the precise location of the video camera 120/sensor 130, as is described in greater detail below. Alternatively, the tracking system 150 may employ infrared technology to determine the precise location of the video camera 120/sensor 130, or else may employ fiber-optic tracking, magnetic tracking, etc. An object registration module 160 is configured, according to one example embodiment of the present invention, to process data corresponding to the position of the object of interest 110 in order to determine the location of the object of interest 110.

A sensed data processor 140 obtains sensed data from the sensor 130. The sensed data may be any conceivable type of sensor data that is sensed at a location at or close to the object of interest 110. For instance, and as previously described above, depending on the type of sensor 130 that is employed by the augmented reality system 100 of the present invention, the sensed data may include data corresponding to a chemical condition, such as the pH value, the oxygen levels or the glucose levels, etc., or may be data corresponding to a physical condition, such as sound, pressure flow, electrical activity, magnetic activity, etc. The sensed data processor 140 may also, according to one embodiment of the present invention, be configured to process the sensed data for the purpose of characterizing or classifying it, as will be explained in greater detail below.

A computed data storage module 170 stores computed data. The computed data may be any conceivable type of data corresponding to the object of interest 110. For instance, in accordance with one example embodiment of the invention, the computed data is data corresponding to a test procedure that was performed on the object of interest 110 at a previous time. In the example of the brain tumor surgery discussed above, the computed data stored by the computed data storage module 170 may include data corresponding to an MRI that was previously performed on the patient.

An augmented reality processor 180 is coupled to the tracking system 150. According to the example embodiment shown, the augmented reality processor 180 is configured to receive the tracking data that is obtained by the tracking system 150 with respect to the location of the video camera 120, the robotic positioning device 125 and/or the sensor 130. In addition, the augmented reality processor 180 is coupled to the object registration module 160. According to the example embodiment shown, the augmented reality processor 180 is configured to receive the position data that is obtained by the object registration module 160 with respect to the location of the object of interest 110. Furthermore, the augmented reality processor 180 is coupled to the video camera 120. According to the example embodiment shown, the augmented reality processor 180 is configured to receive the video data that is obtained by the video camera 120, e.g., a video representation of the object of interest 110. Also, the augmented reality processor 180 is coupled to the sensed data processor 140. According to the example embodiment shown, the augmented reality processor 180 is configured to receive the sensed data that is obtained by the sensor 130 that may or may not be processed after it has been obtained. Finally, the augmented reality processor 180 is coupled to the computed data storage module 170. According to the example embodiment shown, the augmented reality processor 180 is configured to receive the computed data that is stored in the computed data storage module 170, e.g., MRI data, CT data, etc. The computed data received from the computed data storage module 170 may, according to one embodiment of the present invention, be co-registered with the object of interest 110 using a method whereby a set of points or surfaces from the virtual data is registered with the corresponding set of points or surfaces of the real object, enabling a total volume of the object to be co-registered, as is discussed in more detail below.

The augmented reality processor 180 is configured to process the data received from the tracking system 150, the object registration module 160, the video camera 120, the sensed data processor 140 and the computed data storage module 170. More particularly, the augmented reality processor 180 is configured to process the data from these sources in order to generate an augmented reality image 191 that is displayed on the display device 190. The augmented reality image 191 is a composite image that includes both a video image 192 corresponding to the video data obtained from the video camera 120 and a data image 193. The data image 193 may include an image corresponding to the sensed data that is received by the augmented reality processor 180 from the sensor 130 via the sensed data processor 140, and/or may include an image corresponding to the computed data that is received by the augmented reality processor 180 from the computed data storage module 170.

In order to generate the augmented reality image 191, the augmented reality processor 180 advantageously employs the tracking system 150 and the object registration module 160 in order to ensure that the data image 193 that is merged with the video image 192 corresponds both in time and in space to the video image 192. In other words, at any given point in time, the video image 192 that is obtained from the video camera 120 and that is displayed on the display device 190 corresponds spatially to the data image 193 that is obtained from either the sensed data processor 140 or the computed data storage module 170 and that is displayed on the display device 190. The resulting augmented reality image 191 eliminates the need for a user to separately view both a video image obtained from a video camera and displayed on a display device and a separate image having additional information but displayed on a different display media or a different display device, as required in a conventional system.

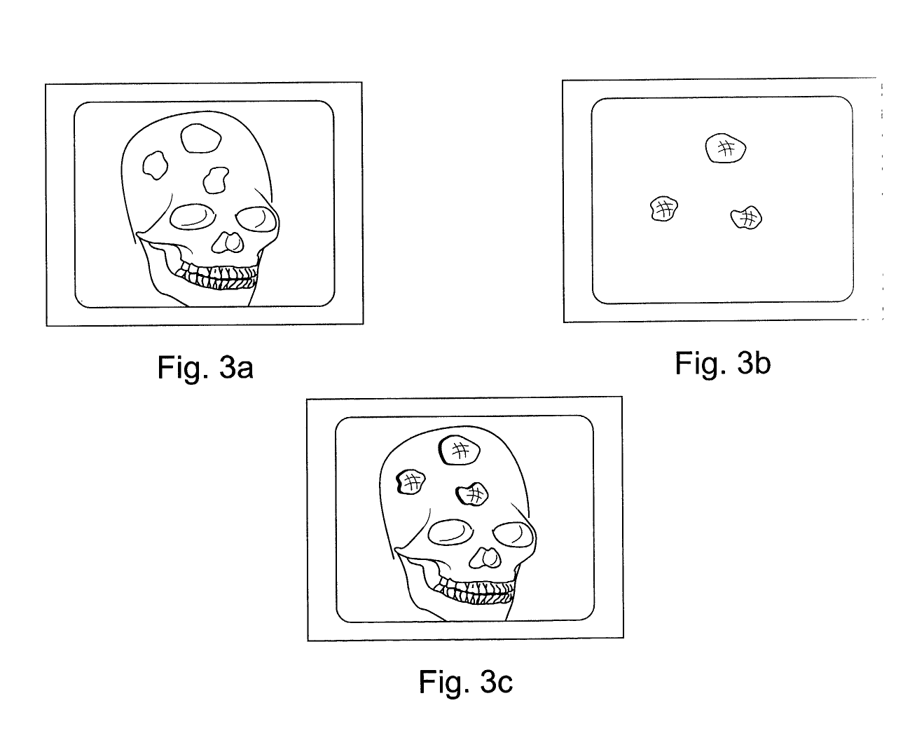

FIGS. 3(a) through 3(c) illustrate, by way of example, the various elements of an augmented reality image 191. For instance, FIG. 3(a) illustrates a view of a representation of a human head 10, constituting a video image 192. The video image 192 shows the human head 10 as having various pockets 15 disposed throughout. In addition, the video image 192 of the human head 10 is obtained by a video camera (not shown) maintained in a particular position. FIG. 3(b), on the other hand, illustrates a view of a representation of several tumors 20, constituting a data image 193. The data image 193 of the several tumors 20 is obtained by a sensor (not shown) that was advantageously maintained in a position similar to the position of the video camera. FIG. 3(c) illustrates the augmented reality image 191, which merges the video image 192 showing the human head 10 and the data image 193 showing the several tumors 20. Due to the registration of the video image 192 and the data image 193, the augmented reality image 191 shows the elements of the data image 193 as they would appear if they were visible to the video camera. Thus, in the example embodiment shown, the several tumors 20 of the data image 193 are shown as residing within their corresponding pockets 15 of the human head 10 in the video image 192. The method by which the system 100 of the present invention employs the tracking and registration features is discussed in greater detail below.

In order to accomplish this correspondence between the data image 192 and the video image 193, the augmented reality processor 180 determines the position and orientation of the video camera 120 relative to the object of interest 110. According to one example embodiment of the present invention, this is accomplished by employing a video camera 120 having a pin-hole, such as pin-hole 121. The use of the pin-hole 121 in the video camera 120 enables the processor to employ the pin-hole 121 as a reference point for determining the position and orientation of an object of interest 110 located in front of the video camera 120.

According to another example embodiment of the present invention, in order to accomplish the correspondence between the data image 192 and the video image 193, the augmented reality processor 180 determines the position and orientation of the video camera 120 relative to the object of interest 110 by tracking the movement and/or position of the robotic positioning device 125. According to this embodiment, forward kinematics are employed by the augmented reality processor 180 in order to calculate the position of the end-effector 126 of the robotic positioning device 125 relative to the position of a base 127 of the robotic positioning device 125. Advantageously, the augmented reality processor 180 employs a coordinate system in order to determine the relative positions of several sections of the robotic positioning device 125 in order to eventually determine the relative position of the end-effector 126 of the robotic positioning device 125 and the position of instruments, e.g., the video camera 120 and the sensor 130, mounted thereon.

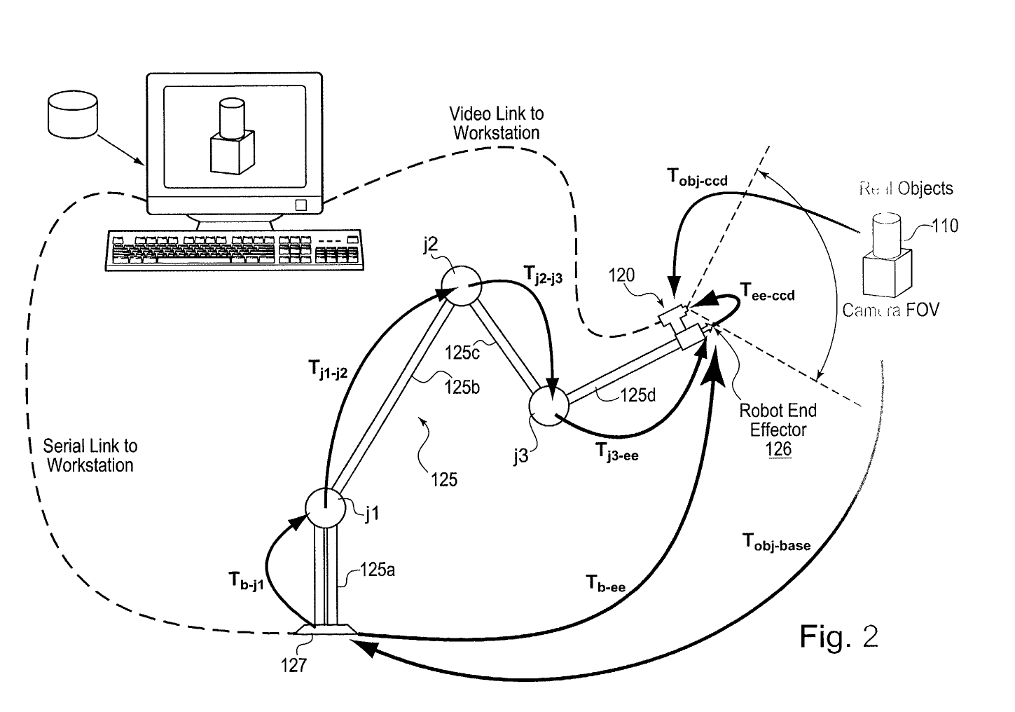

FIG. 2 is a schematic diagram that illustrates a robotic positioning device 125 having four robotic position device segments 125a, 125b, 125c and 125d. The robotic positioning device segment 125a is attached to the base 127 of the robotic positioning device 125 and terminates at its opposite end in a joint designated as “j1”. The robotic positioning device segment 125b is attached at one end to the robotic positioning device segment 125a by joint “j1”, and terminates at its opposite end in a joint designated as “j2”. The robotic positioning device segment 125c is attached at one end to the robotic positioning device segment 125b by joint “j2”, and terminates at its opposite end in a joint designated as “j3”. The robotic positioning device segment 125d is attached at one end to the robotic positioning device segment 125c by joint “j3”. The opposite end of the robotic positioning device segment 125d functions as the end-effector 126 of the robotic positioning device 125 having mounted thereon the video camera 120, and is designated as “ee”. As shown in FIG. 2, an object of interest 110 is positioned in front of the video camera 120.

In order to determine the relative positions of each element of the system 100, the coordinate locations of each segment of the robotic positioning device 125 is calculated and a transformation corresponding to the relative position of each end of the robotic segment is ascertained. For instance, a coordinate position of the end of the robotic positioning device segment 125a designated as “j1” relative to the coordinate position of the other end of the robotic positioning device segment 125a where it attaches to the base 127 is given by the transformation T_{b-j1}. Similarly, a coordinate position of the end of the robotic positioning device segment 125b designated as “j2” relative to the coordinate position of the other end of the robotic positioning device segment 125b designated as “j1” is given by the transformation Tⱼ₁₋ⱼ₂. A coordinate position of the end of the robotic positioning device segment 125c designated as “j3” relative to the coordinate position of the other end of the robotic positioning device segment 125c designated as “j2” is given by the transformation Tⱼ₂₋ⱼ₃. A coordinate position of the end-effector 126 of the robotic positioning device segment 125d, designated as “ee”, relative to the coordinate position of the other end of the robotic positioning device segment 125d, designated as “j3”, is given by the transformation Tⱼ₃₋ₑₑ. A coordinate position of the center of the video camera 120, designated as “ccd”, relative to the coordinate position of the end-effector 126 of the robotic positioning device 125, designated as “ee” is given by the transformation T_{ee-ccd}. A coordinate position of the object of interest 110, designated as “obj”, relative to the center of the video camera 120, designated as “ccd”, is given by the transformation T_{obj-ccd}.

Employing these transformations, the augmented reality processor 180, in conjunction with the object registration module 160, may determine the precise locations of various elements of the system 100. For instance, the coordinate position of the end-effector 126 of the robotic positioning device 125 relative to the base 127 of the robotic positioning device 125 may be determined using the following equation:

T_{b-ee}=T_{b-J1}×Tⱼ₁₋ⱼ₂×Tⱼ₂₋ⱼ₃×Tⱼ₃₋ₑₑ

Similarly, the coordinate position of the object of interest 110 relative to the center of the video camera 120 may be determined using the following equation:

T_{obj-ccd}=T_{obj-base}×T_{base-ee}×T_{ee-ccd}

In the embodiment shown, knowing the position of the object of interest 110 relative to the center of the video camera 120 enables the augmented reality processor 180 to overlay, or merge, with the video data 192 displayed on the display device 190 the corresponding sensed or computed data. The corresponding sensed data may be data that is obtained by the sensor 130 when the sensor 130 is located and/or oriented in the same position as the video camera 120. Alternatively, the corresponding sensed data may be data that is obtained by the sensor 130 when the sensor 130 is in a different position than the video camera, and that is processed so as to simulate data that would have been obtained by the sensor 130 if the sensor 130 had been located and/or oriented in the same position as the video camera 120. Similarly, the corresponding computed data may be data that is stored in the computed data storage module 170 and that was previously obtained by a sensor (not shown) that was located and/or oriented in the same position as the video camera 120. Alternatively, the corresponding computed data may be data that is stored in the computed data storage module 170 and that was obtained by a sensor (not shown) when the sensor was in a different position than the video camera, and that is processed so as to simulate data that would have been obtained by the sensor if the sensor had been located and/or oriented in the same position as the video camera 120. In still another example embodiment of the present invention, the computed data may be obtained by another computed method such as MRI, and may be co-registered with the real object by means of point or surface registration. An exemplary embodiment employing each of these scenarios is provided below.

For instance, in the first example embodiment, the sensed data that corresponds to and is merged with the video data 192 displayed on the display device 190 is data that is obtained by the sensor 130 when the sensor 130 is located and/or oriented in substantially the same position as the video camera 120. In the embodiment shown in FIG. 2, the video camera 120 and the sensor 130 are positioned on the end-effector 126 of the robotic positioning device 125 adjacent to each other. However, the present invention also contemplates that the sensor 130 and the video camera 120 may be located at the same position at any given point in time, e.g., the video camera 120 and the sensor 130 are “co-positioned”. By way of example, the sensor 130 may be a magnetic resonance imaging device that obtains magnetic resonance imaging data using the video camera 120, thereby occupying the same location as the video camera 120 at a given point in time. In this manner, the data image 193 that is displayed on the display device 190 corresponds to the sensed data that is obtained by the sensor 130 from the same position that the video camera 120 obtains its video data. Thus, the data image 193, when merged with the video image 192 obtained from the video data of the video camera 120, accurately reflects the conditions at the proximity of the object of interest 110. Also, it is noted that, if the position of the sensor 130 and the video camera 120 are relatively close to each other rather than precisely the same, the system 100 of the present invention, according to one embodiment thereof, may merge the video image 192 and the data image 193 even though the data image 193 does not exactly correspond to the video image 192.

In the second example embodiment described above, the sensed data that corresponds to and creates the data image 193 that is merged with the video image 192 displayed on the display device 190 is data that is obtained by the sensor 130 when the sensor 130 is in a different position than the video camera 120. In this embodiment, the sensed data is processed so as to simulate data that would have been obtained by the sensor 130 if the sensor 130 had been located and/or oriented in the same position as the video camera 120. In the embodiment shown in FIG. 2, the video camera 120 and the sensor 130 are positioned on the end-effector 126 of the robotic positioning device 125 so as to be adjacent to each other. Thus, at any given point in time, the sensed data obtained by the sensor 130 corresponds to a position that is slightly different from the position that corresponds to the video data that is obtained from the video camera 120. In accordance with one embodiment of the present invention, at least one of the sensed data processor 140 and the augmented reality processor 180 is configured to process the sensed data obtained from the sensor 130. Advantageously, at least one of the sensed data processor 140 and the augmented reality processor 180 is configured to process the sensed data so as to simulate the sensed data that would be obtained at a position different from the actual position of the sensor 130. Preferably, at least one of the sensed data processor 140 and the augmented reality processor 180 is configured to process the sensed data so as to simulate the sensed data that would be obtained if the sensor 130 was positioned at the same position as the video camera 120. In this manner, the data image 193 that is displayed on the display device 190 corresponds to the simulated sensed data that would be obtained if the sensor 130 was positioned at the same position as the video camera 120, rather than the actual sensed data that was obtained by the sensor 130 at its actual position adjacent to the video camera 120. By performing this simulation processing step, the data image 193, when merged with the video image 192 obtained from the video data of the video camera 120, more accurately reflects the conditions at the proximity of the object of interest.

According to one embodiment of the present invention and as briefly mentioned above, the sensed data processor 140 may also be configured to process the sensed data obtained by the sensor 130 for the purposes of characterizing or classifying the sensed data. In this manner, the system 100 of the present invention enables a “smart sensor” system that assists a person viewing the augmented reality image 191 by supplementing the information provided to the person. According to one embodiment of the present invention, the sensed data processor 140 may provide the characterized or classified sensed data to the augmented reality processor 180 so that the augmented reality processor 180 displays the data image 193 on the display device 160 in such a way that a person viewing the display device is advised of the characteristic or category to which the sensed data belongs. For instance, with regards to the above-described example of a surgeon employing the system 100 of the present invention to operate on a brain tumor, the sensor 130 may be configured to sense pH, O₂, and/or glucose characteristics in the vicinity of the brain tumor. The sensed data corresponding to the pH, O₂, and/or glucose characteristics in the vicinity of the brain tumor may be processed by the sensed data processor 140 in order to classify the type of tumor that is present as either a benign tumor or a malignant tumor. Having classified the tumor as being either benign or malignant, the sensed data processor 140 may then provide the sensed data to the augmented reality processor 180 in such a way, e.g., via a predetermined signal, so as to cause the augmented reality processor 180 to display the data image 193 on the display device 160 in one of two different colors. If the tumor was classified by the sensed data processor 140 as being benign, the data image 193 corresponding to the tumor may appear on the display device 190 in a first color, e.g., blue. If the tumor was classified by the sensed data processor 140 as being malignant, the data image 193 corresponding to the tumor may appear on the display device 190 in a second color, e.g., red. In this way, the surgeon viewing the augmented reality image 191 on the display device 190 is provided with visual data that enables him or her to perform the surgical procedure in the most appropriate manner, e.g., to more effectively determine tumor resection limits, etc. Of course, it should be obvious that the display of the data image 193, in order to differentiate between different characteristics or classifications of sensed data, may be accomplished by a variety of different methods, of which providing different colors is merely one example, and the present invention is not intended to be limited in this respect.

In the third example embodiment described above, the computed data that corresponds to and is merged with the video data 192 displayed on the display device 190 is data that is stored in the computed data storage module 170 and that was previously obtained by a sensor (not shown) that was located and/or oriented in the same position as the video camera 120. In this embodiment, a user may be able to employ data that was previously obtained about an object of interest 110 from a sensor that was previously located in a position relative to the object of interest 110 that is the same as the current position of the video camera 120 relative to the object of interest 110. For instance, during the course of a brain surgery operation, the video camera 120 may be located in a particular position relative to the patient's head. As previously discussed, the video image 192 that is displayed on the display device 190 is data that is obtained by the video camera 120 in that particular position relative to the patient's head. Prior to the brain surgery operation, the patient may have undergone a diagnostic test, such as magnetic resonance imaging. Advantageously, the magnetic resonance imaging device (not shown) was, during the course of the test procedure, located in a position relative to the patient's head that is the same as the particular position of the video camera 120 at the current time relative to the patient's head (in an alternative embodiment, discussed in greater detail below, the magnetic resonance imaging data may be acquired in a different position and is co-registered with the patient's head using some markers, anatomical features or extracted surfaces). The data obtained by the magnetic resonance device when in this position is stored in the computed data storage module 170. Since the augmented processor 180 knows the current position of the video camera 120 via the tracking system 150, the augmented processor 180 may obtain from the computed data storage module 170 the magnetic resonance data corresponding to this same position, and may employ the magnetic resonance data in order to generate a data image 193 that corresponds to the displayed video image 192.

In the fourth example embodiment described above, the computed data that corresponds to and is merged with the video data 192 displayed on the display device 190 is data that is stored in the computed data storage module 170 and that was obtained by a sensor (not shown) when the sensor was in a different position than the video camera. In this embodiment, the computed data is further processed by either the computed data storage module 170 or the augmented reality processor 180 so as to simulate data that would have been obtained by the sensor if the sensor had been located and/or oriented in the same position as the video camera 120. In this embodiment, a user may be able to employ data that was previously obtained about an object of interest from a sensor that was previously located in a position relative to the object of interest that is different from the current position of the video camera 120 relative to the object of interest. For instance and as described in the previous embodiment, during the course of a brain surgery operation, the video camera 120 may be located relative to the patient's head in a particular position, and the video image 192 that is displayed on the display device 190 is data that is obtained by the video camera 120 in that particular position relative to the patient's head. Prior to the brain surgery operation, the patient may have undergone a diagnostic test, such as magnetic resonance imaging. In this case, during the course of the test procedure, the magnetic resonance imaging device was not located in a position relative to the patient's head that is the same as the particular position of the video camera 120 at the current time relative to the patient's head, but was located in a different relative position or in various different relative positions. The data obtained by the magnetic resonance device when in this or these different positions is again stored in the computed data storage module 170. Since the augmented processor 180 knows the position of the video camera 120 via the tracking system 150, the augmented processor 180 may obtain from the computed data storage module 170 the magnetic resonance data corresponding to the different positions, and may process the data so as to simulate data as though it had been obtained from the same position as the video camera 120. The augmented reality processor 180 may then employ the simulated magnetic resonance data in order to generate a data image 193 that corresponds to the displayed video image 192. Alternatively, the processing of the computed data in order to simulate video data obtained from different positions may be performed by the computed data storage module 170, rather than the augmented reality processor 180. According to one example embodiment of the present invention, when obtained from various different positions, the computed data may be processed so as to generate a three-dimensional image that may be employed in the augmented reality image 191. According to another embodiment of the present invention, pattern recognition techniques may be employed.

As previously discussed, the system 100 of the present invention, according to various embodiments thereof, may employ a wide variety of tracking techniques in order to track the position of the video camera 120, the sensor 130, etc. Some of these tracking techniques include using an infrared camera stereoscopic system, using a precise robot arm as previously discussed, using magnetic, sonic or fiber-optic tracking techniques, and using image processing methods and pattern recognition techniques for camera calibration. With respect to image processing techniques, the use of a video camera 120 having a pin-hole 121 was discussed previously and provides a technique for directly measuring the location and orientation of the coupled charged device (hereinafter referred to as “CCD”) array inside the camera relative to the end-effector 126 of the robotic positioning device 125. While this technique produces adequate registration results, a preferred embodiment of the present invention employs a video camera calibration technique, such as the technique described in Juyang Weng, Paul Cohen and Marc Herniou, “Camera Calibration with Distortion Models and Accuracy Evaluation”, IEEE Transaction on Pattern Analysis and Machine Intelligence, Vol 14, No. 10 (October 1992), which is incorporated by reference herein as fully as if set forth in its entirety. According to this technique, well-known points in world coordinates are collected. A processor, such as the augmented reality processor 180, then extracts their pixel coordinates in image coordinates. A nonlinear optimization approach is then employed to estimate the model parameters by minimizing a nonlinear objective function. The present invention may also incorporate techniques as described in R. Tsai, “A Versatile Camera Calibration Technique for High Accuracy 3D Machine Vision Metrology Using Off-the-Shelf TV Cameras and Lenses”, IEEE Joumal of Robotics and Automation, vol. RA-3, No. 4 (August 1987), which is also incorporated by reference herein as fully as if set forth in its entirety

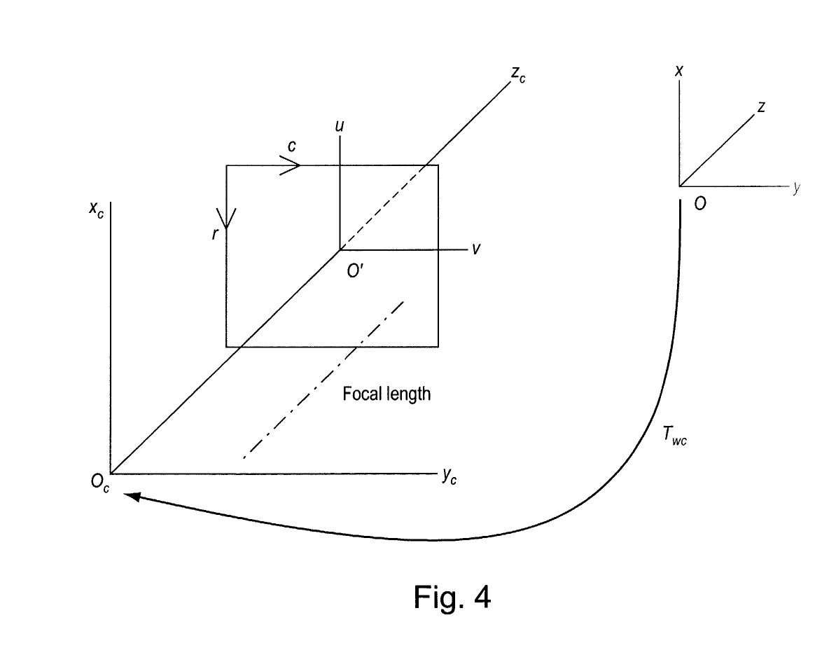

More specifically, FIG. 4 is a diagram that illustrates a reference system that may be employed by the augmented reality processor 180 in order to determine positions and orientations of objects of interest 110. According to FIG. 4, the points x, y, and z represent the coordinates of any visible point P in a fixed coordinate system, e.g, a world coordinate system, while the points x_{c}, y_{c}, and Z_{c} represent the coordinates of the same point in a camera-centered coordinate system, e.g., a pin-hole 121 in the lens of the video camera 120. Advantageously, the coordinates of the camera-centered coordinate system coincide with the optical center of the camera and the Z_{c} axis coincides with its optical axis. In addition, the following relationships are evident:

u=ƒx_{c}/z_{c}

v=ƒy_{c}/z_{c}

r−r₀=sᵤu

c−c₀=sᵥv

The image plane, which corresponds to the image-sensing array, is advantageously parallel to the (x_{c}, y_{c}) plane and a distance of “f” to the origin. The relationship between the world and camera coordinate systems is given by the relationship:

$$( \begin{matrix}{x}_{c} \\ {y}_{c} \\ {z}_{c}\end{matrix} ) = R ( \begin{matrix}x \\ y \\ z\end{matrix} ) + T ↔ {T}_{wc}$$

wherein R=(rᵢⱼ) is a 3×3 rotation matrix defining the camera orientation and T=(t₁, t₂, t₃)^{T}. According to the technique described in Tsai, the Tsai model governs the following relationships between a point of the world space (xᵢ, yᵢ, zᵢ) and its projection on the camera CCD (rᵢ, cᵢ):

$$\begin{matrix} {u}_{i} / f = \frac{{r}_{i} - {r}_{0}}{{f}_{u}} = \frac{{r}_{1 , 1} {x}_{i} + {r}_{1 , 2} {y}_{i} + {r}_{1 , 3} {z}_{i} + {t}_{1}}{{r}_{3 , 1} {x}_{i} + {x}_{3 , 2} {y}_{i} + {r}_{3 , 3} {z}_{i} + {t}_{3}} \\ and {v}_{i} / f = \frac{{c}_{i} - {c}_{0}}{{f}_{v}} = \frac{{r}_{2 , 1} {x}_{i} + {r}_{2 , 2} {y}_{i} + {r}_{2 , 3} {z}_{i} + {t}_{2}}{{r}_{3 , 1} {x}_{i} + {x}_{3 , 2} {y}_{i} + {r}_{3 , 3} {z}_{i} + {t}_{3}} {(}^{*} )\end{matrix}$$

These equations are formulated in an objective function so that finding the optimum (minimum or maximum) of the function leads us to the camera parameters. For the time being, the camera parameters are r₀, c₀, fᵤ, fᵥ, R and T. and the information available includes the world space points (xᵢ, yᵢ, zᵢ) and their projections (rᵢ, cᵢ). The objective function is as follows:

$${X}^{2} = {\sum }_{i = 1}^{n} \{ {[ {\hat{r}}_{j} + {r}_{i} ( m ) ]}^{2} + {[ {\hat{c}}_{i} + {c}_{i} ( m ) ]}^{2} \}$$

where, “m” is the Tsai's model of distortion-free camera, (rᵢ, cᵢ) is our observation of the projection of the i-th point on the CCD, and (rᵢ(m), cᵢ(m)) is its estimation based on the current estimate of the camera model. The above objective function is a linear minimum variance estimator, as described in Weng92, having as many as n observed points in the world space.

In accordance with an alternative embodiment of the present invention, the augmented reality processor is configured to select a different objective function derived from the above-referenced equations, e.g., by performing a cross product and taking all the terms to one side. According to this embodiment, the following equations and objective functions apply:

Aᵢ(ƒᵤ,r_{1,1},r_{1,2},r_{1,3},r_{3,1},r_{3,2},r_{3,3},r₀,t₁,t₃)=ƒᵤ(r_{1,1}xᵢr_{1,2}yᵢ+r_{1,3}zᵢ+t₁)−(rᵢ−r₀)(r_{3,1}xᵢ+r_{3,2}yᵢ+r_{3,3}zᵢ+t₃)≈0

Bᵢ(ƒᵥ,r_{2,1},r_{2,2},r_{2,3},r_{3,1},r_{3,2},r_{3,3},c₀,t₂,t₃)=ƒᵤ(r_{2,1}xᵢr_{2,2}yᵢ+r_{2,3}zᵢ+t₂)−(cᵢ−c₀)(r_{3,1}xᵢ+r_{3,2}yᵢ+r_{3,3}zᵢ+t₃)≈0

and

$${χ}^{2} = {\sum }_{i = 1}^{n} ( {A}_{i}^{2} + {B}_{i}^{2} ) .$$

The augmented reality processor 180 then minimizes this term such that it has a value of zero at its minimum. A and B, as referring to the terms above, are approximately zero because for each set of input values, there is a corresponding error of digitization (or the accuracy of the digitization device).

Advantageously, the augmented reality processor 180 is configured to then optimize the objective function by employing the gradient vector, as specified by the following equation:

$$∇ {χ}^{2} = \frac{\partial {χ}^{2}}{\partial a} = [ \frac{\partial {χ}^{2}}{\partial {r}_{11}} ⋯ \frac{\partial {χ}^{2}}{\partial {r}_{33}} \frac{\partial {χ}^{2}}{\partial {f}_{u}} \frac{\partial {χ}^{2}}{\partial {f}_{v}} \frac{\partial {χ}^{2}}{\partial {c}_{0}} \frac{\partial {χ}^{2}}{\partial {r}_{0}} \frac{\partial {χ}^{2}}{\partial {t}_{1}} \frac{\partial {χ}^{2}}{\partial {t}_{2}} \frac{\partial {χ}^{2}}{\partial {t}_{3}} ]$$

where ‘α’ is the parameter vector. For instance, the steepest descent method would be stepped down in gradient vector direction. In other words:

αₙₑₓₜ=α_{cur}−cons×∇χ²(α_{cur}) which implies δα₁=cons×β₁

Where α_{cur} and αₙₑₓₜ are the current and the next parameter vectors, respectively. ∇χ²(α_{cur}) is the gradient vector of the objective function at the current parameter point. δα_{I} is the difference between the next and current Iₜₕ-parameter and β_{I} is the corresponding Iₜₕ gradient. In order to have an accurate and stable approach, the augmented reality processor 180 may select a small value for ‘cons’, so that numerous iterations are performed before reaching the optimum point, thereby causing this technique to be slow.

According to one embodiment of the present invention, the augmented reality processor 180 employs a different technique in order to reach the optimum point more quickly. For instance, in one embodiment of the present invention, the augmented reality processor 180 employs a Hessian approach, as illustrated below:

αₘᵢₙ=α_{cur}+D⁻¹·[∇χ²(α_{cur})] which implies

$${\sum }_{l = 1}^{M} {α}_{kl} \cdot δ {a}_{1} = {β}_{k}$$

wherein αₘᵢₙ is the parameter vector in which the objective function is minimum. αₖₗ is the (kₜₕ, Iₜₕ) element of the Hessian matrix. In order to employ this approach, the augmented reality processor 180 is configured to assume that the objective function is quadratic. However, since this is not always the case, the augmented reality processor 180 may employ an alternative method, such as the method proposed by Marquardt that switches continuously between two methods, and that is known as the Levenberg-Marquardt method. In this method, a first formula, as previously discussed, is employed:

αₙₑₓₜ=α_{cur}−cons×∇χ²(α_{cur}) which implies δα₁=cons×β₁

such that, if ‘cons’ is considered as 1/λα_{II}, where λ is a scaling factor, the return value of the objective function will be a pure and non-dimensional number in the formula. To then employ the Levenberg-Marquardt method, the augmented reality processor 180 then changes the Hessian matrix on its main diagonal according to a second formula, such that:

$$α ( i , j ) = \{ \begin{matrix}{α}_{ij} ( 1 + λ ) & if i = j \\ {α}_{ij} & if i \neq j\end{matrix}$$

If the augmented reality processor 180 selects a value for λ that is very large, the first formula migrates to the formula employed in the Hessian approach, since the contributions of αₖₗ, where k≠l would be too small. The augmented reality processor 180 is configured to adjust the scaling factor, λ, such that the method employed minimizes the disadvantages of the previously described two methods. Thus, in order to implement a camera calibration, the augmented reality processor 180, according to one embodiment of the invention, may first solve a linear equation set proposed by Weng to get the rotational parameters, and fu, fv, r0, and c0, and may then employ the non-linear optimization approach described above to obtain the translation parameters.

As previously mentioned, the above-described example embodiment of the present invention, which generates an augmented reality image for display to a surgeon during the performance of a surgical procedure relating to a brain tumor, is merely one of many possible embodiments of the present invention. For instance, the augmented reality image generated by the system of the present invention may be displayed to a surgeon during the performance of any type of surgical procedure.

Furthermore, the sensed data that is obtained by the sensor 130 during the performance of the surgical procedure may encompass any type of data that is capable of being sensed. For instance, the sensor 130 may be a magnetic resonance imaging device that obtains magnetic resonance data corresponding to an object of interest, whereby the magnetic resonance data is employed to generate a magnetic resonance image that is merged with the video data obtained by the video camera 120 so as to generate the augmented reality image 191. According to another example embodiment, the sensor 130 may be a pressure sensing device that obtains pressure data corresponding to an object of interest, e.g., the pressure of blood is a vessel of the body, whereby the pressure data is employed to generate an image that shows various differences in pressure and that is merged with the video data obtained by the video camera 120 so as to generate the augmented reality image 191. Likewise, the sensed data and the computed data may comprise, according to various embodiments of the present invention, data corresponding to and obtained by a magnetic resonance angiography (“MRA”) device, a magnetic resonance spectroscopy (“MRS”) device, a positron emission tomography (“PET”) device, a single photon emission tomography (“SPECT”) device, a computed tomography (“CT”) device, etc., in order to enable the merging of real-time video data with segmented views of vessels, tumors, etc. Furthermore, the sensed data and the computed data may comprise, according to various embodiments of the present invention, data corresponding to and obtained by a biopsy, a pathology report, etc. thereby enabling the merging of real-time video data with the biopsies or pathology reports. The system 100 of the present invention also has applicability in medical therapy targeting wherein the sensed data and the computed data may comprise, according to various embodiments of the present invention, data corresponding to radiation seed dosage requirements, radiation seed locations, biopsy results, etc. thereby enabling the merging of real-time video data with the therapy data.

In addition and as previously mentioned, it should be understood that the system of the present invention may be used in a myriad of different applications other than for performing surgical procedures. For instance, according to one alternative embodiment of the present invention, the system 100 is employed to generate an augmented reality image in the aerospace field. By way of example, a video camera 120 mounted on the end-effector 126 of a robotic positioning device 125 may be employed in a space shuttle to provide video data corresponding to an object of interest, e.g., a structure of the space shuttle that is required to be repaired. A sensor 130 mounted on the same end-effector 126 of the robotic positioning device 125 may sense any phenomenon in the vicinity of the object of interest, e.g., an electrical field in the vicinity of the space shuttle structure. The system 100 of the present invention may then be employed to generate an augmented reality image 191 that merges a video data image 192 of the space shuttle structure obtained from the video camera 120 and a sensed data image 193 of the electrical field obtained from the sensor 130. The augmented reality image 191, when displayed to an astronaut on a display device such as display device 190, would enable the astronaut to determine whether the electrical field in the region of the space shuttle structure will effect the performance of the repair of the structure. Alternatively, computed data corresponding to the structure of the space shuttle required to be repaired may be stored in the computed data storage module 170. For instance, the computed data may be a stored three-dimensional representation of the space shuttle structure in a repaired state. The system 100 of the present invention may then be employed to generate an augmented reality image 191 that merges a video data image 192 of the broken space shuttle structure obtained from the video camera 120 and a computed data image 193 of the space shuttle structure in a repaired state as obtained from the computed data storage module 170. The augmented reality image 191, when displayed to an astronaut on a display device such as display device 190, would enable the astronaut to see what the completed repair of the space shuttle structure should look like when completed. Of course, it should be obvious that the system of the present invention may be employed in the performance of any type of task, whether it be surgical, repair, observation, etc., and that the performance of the task may be employed by any conceivable person, e.g., a surgeon, an astronaut, an automobile mechanic, a geologist, etc., or may be performed by an automated system configured to evaluate the augmented reality image generated the system 100.

Thus, the several aforementioned objects and advantages of the present invention are most effectively attained. Those skilled in the art will appreciate that numerous modifications of the exemplary embodiments described herein above may be made without departing from the spirit and scope of the invention. Although various exemplary embodiments of the present invention have been described and disclosed in detail herein, it should be understood that this invention is in no sense limited thereby and that its scope is to be determined by that of the appended claims.

What is claimed is:

1. A system for generating an augmented reality image, comprising:
a video camera for obtaining real-time video data corresponding to an object of interest;
a sensor for obtaining sensed data corresponding to the object of interest;
an augmented reality processor coupled to the video camera and to the sensor, the augmented reality processor configured to receive the video data from the video camera and to receive the sensed data from the sensor; and
a display device coupled to the augmented reality processor, wherein the augmented reality processor is further configured to generate for display on the display device a video image from the video data received from the video camera and to generate a corresponding data image from the sensed data received from the sensor, and wherein the augmented reality processor is further configured to merge the video image and the corresponding data image so as to generate the augmented reality image.

2. The system of claim 1, further comprising a registration module for registering at least one of the object of interest and the video camera, such that the data image corresponds spatially to the video image.

3. The system of claim 1, further comprising a tracking system, wherein the tracking system is configured to determine the position of the video camera relative to an object of interest.

4. The system of claim 3, wherein the tracking system is further configured to determine the position of the sensor relative to an object of interest, so as to enable the registration of the data image and the video image.

5. The system of claim 4, further comprising a robotic positioning device, wherein the robotic positioning device has an end-effector on which is mounted at least one of the video camera and the sensor.

6. The system of claim 5, wherein the tracking system determines the position of at least one of the video camera and the sensor by determining the relative position of the robotic positioning device.

7. The system of claim 6, wherein the robotic positioning device includes a plurality of robotic positioning device segments, each robotic positioning device segment coupled to an adjacent robotic positioning device segment, and wherein the tracking system determines the position of the video camera by employing the position of each robotic positioning device segment relative to the position of its adjacent robotic positioning device segment.

8. The system of claim 3, wherein the tracking system employs an infrared camera to track the position of at least one of the video camera and the sensor.

9. The system of claim 3, wherein the tracking system employs a fiber-optic system to track the position of at least one of the video camera and the sensor.

10. The system of claim 3, wherein the tracking system magnetically tracks the position of at least one of the video camera and the sensor.

11. The system of claim 3, wherein the tracking system employs image processing to track the position of at least one of the video camera and the sensor.

12. The system of claim 1, wherein the sensor is configured to sense a chemical condition at or near the object of interest.

13. The system of claim 12, wherein the sensor is configured to sense a chemical condition at or near the object of interest selected from a group of consisting of pH, O₂ and glucose levels.

14. The system of claim 1, wherein the sensor is configured to sense a physical condition at or near the object of interest.

15. The system of claim 14, wherein the sensor is configured to sense a physical condition at or near the object of interest selected from a group consisting of sound, pressure, flow, electrical energy, magnetic energy, radiation.

16. The system of claim 1, further comprising a sensed data processor coupled to the sensor and to the augmented reality processor, wherein the sensed data processor is configured to at least one of characterize and classify the sensed data corresponding to the object of interest.

17. The system of claim 16, wherein at least one of the augmented reality processor and the sensed data processor is configured to cause the data image to be displayed so as to identify a characteristic or classification determined by the sensed data processor.

18. The system of claim 1, wherein the system is configured to be employed during the performance of a surgical procedure, and wherein the object of interest is a part of a patient's body.

19. The system of claim 1, wherein the system is configured to be employed during the performance of a repair procedure.

20. The system of claim 1, wherein the system is configured to be employed during the performance of an observation procedure.

21. A system for generating an augmented reality image, comprising:
a video camera for obtaining real-time video data corresponding to an object of interest;
a computed data storage module for storing computed data corresponding to the object of interest;
an augmented reality processor coupled to the video camera and to the computed data storage module, the augmented reality processor configured to receive the video data from the video camera and to receive the computed data from the computed data storage module;
a display device coupled to the augmented reality processor, wherein the augmented reality processor is further configured to generate for display on the display device a video image from the video data received from the video camera and to generate a corresponding data image from the computed data received from the computed data storage module, and wherein the augmented reality processor is further configured to merge the video image and the corresponding data image so as to generate the augmented reality image.

22. The system of claim 21, further comprising a registration module for registering at least one of the object of interest and the video camera, such that the data image corresponds spatially to the video image.

23. The system of claim 21, further comprising a tracking system, wherein the tracking system is configured to determine the position of the video camera relative to an object of interest.

24. The system of claim 23, further comprising a robotic positioning device, wherein the robotic positioning device has an end-effector on which is mounted the video camera.

25. The system of claim 24, wherein the tracking system determines the position of the video camera by determining the relative position of the robotic positioning device.

26. The system of claim 25, wherein the robotic position device includes a plurality of robotic positioning device segments, each robotic positioning device segment coupled to an adjacent robotic positioning device segment, and wherein the tracking system determines the position of the video camera by employing the position of each robotic positioning device segment relative to the position of its adjacent robotic positioning device segment.

27. The system of claim 23, wherein the computed data corresponding to the object of interest corresponds to at least one of MRI data, MRS data, CT data, PET data, and SPECT data.

28. The system of claim 23, wherein the tracking system employs at least one of an infrared camera and a fiber-optic system to track the position of the video camera.

29. The system of claim 23, wherein the tracking system at least one of magnetically and sonically tracks the position of the video camera.

30. The system of claim 23, wherein the tracking system employs image processing to track the position of the video camera.

31. The system of claim 21, wherein the computed data includes previously-obtained sensed data corresponding to at least one of MRI data, MRS data, CT data, PET data, and SPECT data.

32. The system of claim 21, wherein the sensed data corresponds to a chemical condition at or near the object of interest, wherein the chemical condition is selected from a group consisting of pH, O₂, CO₂, choline, lactate and glucose levels.

33. The system of claim 21, wherein the computed data is previously-obtained sensed data corresponding to a physical condition at or near the object of interest.

34. The system of claim 33, wherein the sensed data corresponding to the physical condition at or near the object of interest is selected from a group consisting of sound, pressure, flow, electrical energy, magnetic energy, radiation.

35. The system of claim 21, wherein the system is configured to be employed during the performance of a surgical procedure, wherein the object of interest is a part of a patient's body.

36. A method for generating an augmented reality image, comprising the steps of:
obtaining, via a video camera, real-time video data corresponding to an object of interest;
obtaining, via a sensor, sensed data corresponding to the object of interest;
receiving, by an augmented reality processor coupled to the video camera and to the sensor, the video data from the video camera and the sensed data from the sensor;
generating a video image from the video data received from the video camera;
generating a corresponding data image from the sensed data received from the sensor;
merging the video image and the corresponding data image so as to generate the augmented reality image; and
displaying the augmented reality image on a display device coupled to the augmented reality processor.

37. The method of claim 36, further comprising the step of registering, via a registration module, at least one of the object of interest and the video camera, such that the data image corresponds spatially to the video image.

38. The method of claim 36, further comprising the step of tracking, via a tracking system, the position of the video camera relative to an object of interest.

39. The method of claim 38, further comprising the step of tracking, via the tracking system, the position of the sensor relative to an object of interest, so as to enable the registration of the data image and the video image.

40. The method of claim 39, further comprising the step of mounting at least one of the video camera and the sensor on an end-effector of a robotic positioning device.

41. The method of claim 40, further comprising the step of the tracking system determining the position of at least one of the video camera and the sensor by determining the relative position of the robotic positioning device.

42. The method of claim 41, wherein the robotic position device includes a plurality of robotic positioning device segments, each robotic positioning device segment coupled to an adjacent robotic positioning device segment, and wherein the method further comprises the step of the tracking system determining the position of the video camera by employing the position of each robotic positioning device segment relative to the position of its adjacent robotic positioning device segment.

43. The method of claim 38, further comprising the step of the tracking system employing an infrared camera to track the position of at least one of the video camera and the sensor.

44. The method of claim 38, further comprising the step of the tracking system employing a fiber-optic system to track the position of at least one of the video camera and the sensor.

45. The method of claim 38, further comprising the step of the tracking system magnetically tracking the position of at least one of the video camera and the sensor.

46. The method of claim 38, further comprising the step of the tracking system employing image processing to track the position of at least one of the video camera and the sensor.

47. The method of claim 36, wherein the step of obtaining sensed data includes sensing a chemical condition at or near the object of interest.

48. The method of claim 47, wherein the step of obtaining sensed data includes sensing a chemical condition at or near the object of interest selected from a group of consisting of pH, O₂, CO₂, lactate, choline and glucose levels.

49. The method of claim 36, wherein the step of obtaining sensed data includes sensing a physical condition at or near the object of interest.

50. The method of claim 49, wherein the step of obtaining sensed data includes sensing a physical condition at or near the object of interest selected from a group consisting of sound, pressure, flow, electrical energy, magnetic energy, radiation.

51. The method of claim 50, further comprising the step of at least one of characterizing and classifying the sensed data corresponding to the object of interest, wherein the characterizing and classifying step is performed by a sensed data processor coupled to the sensor and to the augmented reality processor.

52. The method of claim 51, further comprising the step of displaying the data image so as to identify a characteristic or classification of the object of interest as determined by the sensed data processor.

53. A method for generating an augmented reality image, comprising the steps of:
obtaining, via a video camera, real-time video data corresponding to an object of interest;
obtaining, via a computed data storage module, computed data corresponding to the object of interest;
receiving, by an augmented reality processor coupled to the video camera and to the computed data storage module, the video data from the video camera and the computed data from the computed data storage module;
generating a video image from the video data received from the video camera;
generating a corresponding data image from the computed data received from the computed data storage module;
merging the video image and the corresponding data image so as to generate the augmented reality image; and
displaying the augmented reality image on a display device coupled to the augmented reality processor.

54. The method of claim 53, further comprising the step of registering, via a registration module, at least one of the object of interest and the video camera, such that the data image corresponds spatially to the video image.

55. The method of claim 53, further comprising the step of tracking, via a tracking system, the position of the video camera relative to an object of interest.

56. The method of claim 55, further comprising the step of registering the data image and the video image.

57. The method of claim 56, further comprising the step of mounting the video camera on an end-effector of a robotic positioning device.

58. The method of claim 57, further comprising the step of the tracking system determining the position of the video camera by determining the relative position of the robotic positioning device.

59. The method of claim 58, wherein the robotic positioning device includes a plurality of robotic positioning device segments, each robotic positioning device segment coupled to an adjacent robotic positioning device segment, and wherein the method further comprises the step of the tracking system determining the position of the video camera by employing the position of each robotic positioning device segment relative to the position of its adjacent robotic positioning device segment.

60. The method of claim 53, further comprising the step of the tracking system employing an infrared camera to track the position of the video camera.

61. The method of claim 53, further comprising the step of the tracking system employing a fiber-optic system to track the position of the video camera.

62. The method of claim 53, further comprising the step of the tracking system magnetically tracking the position of the video camera.

63. The method of claim 53, further comprising the step of the tracking system employing image processing to track the position of the video camera.

64. The method of claim 53, wherein the step of obtaining computed data includes the step of sensing, via a sensor, a chemical condition at or near the object of interest.

65. The method of claim 64, wherein the step of obtaining sensed data includes sensing a chemical condition at or near the object of interest, the chemical condition selected from a group of consisting of pH, O₂, CO₂, lactate, choline and glucose levels.

66. The method of claim 53, wherein the step of obtaining computed data includes the step of sensing a physical condition at or near the object of interest.

67. The method of claim 66, wherein the step of sensing a physical condition at or near the object of interest includes sensing a physical condition selected from a group consisting of sound, pressure, flow, electrical energy, magnetic energy, and radiation.
